(19) United States
(12) Patent Application Publication
(10) Pub. No.: US 2016/0101487 A1
(43) Pub. Date: Apr. 14, 2016

(54) SPOT WELDING ELECTRODE

(71) Applicant: TOYOTA JIDOSHA KABUSHIKI KAISHA, Toyota-shi (JP)

(72) Inventors: Shuhei Ogura, Nagakute-shi (JP); Kazuyuki Ogusu, Okazaki-shi (JP)

(73) Assignee: TOYOTA JIDOSHA KABUSHIKI KAISHA, Toyota-shi (JP)

(21) Appl. No.: 14/872,536

(22) Filed: Oct. 1, 2015

(30) Foreign Application Priority Data
Oct. 10, 2014 (JP) 2014-209076

(51) Int. Cl. B23K 35/02; B23K 11/30; B23K 35/22

(52) U.S. Cl. CPC B23K 35/0205; B23K 35/222; B23K 11/30

(57) ABSTRACT

A spot welding electrode includes a copper alloy, and a sintered tungsten alloy disposed in a tip portion of the spot welding electrode, the tip portion of the spot welding electrode being brought into contact with an object to be welded. The sintered tungsten alloy is connected only at a single flat surface to the copper alloy. A thermal conductivity of the spot welding electrode is within a range from 60 W/mK to 120 W/mK.

### INCORPORATION BY REFERENCE

The disclosure of Japanese Patent Application No. 2014-209076 filed on Oct. 10, 2014 including the specification, drawings and abstract is incorporated herein by reference in its entirety.

### BACKGROUND OF THE INVENTION

1. Field of the Invention

The invention relates to a spot welding electrode.

2. Description of Related Art

Spot welding, which is a highly-efficient welding method among resistance welding methods, is frequently used in assembly lines for assembling, for example, automobiles, aircrafts, and railroad vehicles. Electrodes used in spot welding need to have high electrical conductivity, high thermal conductivity, high strength, and high wear resistance. Further, the materials for the electrodes need to be resistant to deformation so as to withstand continuous spot welding. Copper alloys, such as Cu—Cr and Cu—Cr—Zr, or copper materials in which hard substance, such as Al₂O₃, is dispersed, are used as the materials for spot welding electrodes.

In addition, spot welding electrodes made of composite materials each formed by combining two or more kinds of metal materials are known. For example, Japanese Patent Application Publication No. 04-17982 describes a welding electrode in which a metal material having high electric resistance is connected to a contact portion of a welding electrode made of a copper-based metal, the contact portion being brought into contact with an object to be welded, as a spot welding electrode made of a composite material. Japanese Patent Application Publication No. 04-17982 does not describe that the ratio between one metal of the welding electrode and the other metal of the welding electrode is adjusted.

Japanese Patent Application Publication No. 2006-102775 describes a spot welding electrode in which a core containing tungsten (W) as a base material is embedded in a contact portion of a welding electrode body made of copper (Cu) or a copper (Cu) alloy. The contact portion is brought into contact with an object to be welded. Fine particles having a melting point of not less than 2400° C. and having a mean particle diameter of not more than 2 μm are dispersed in the core, in a range from 0.5 to 10 percent by volume in total. The fine particles are made of one or more kinds of compounds selected from oxides, nitrides, carbides, and borides of group 2A elements, group 4A elements, group 5A elements, group 6A elements, and rare earth elements.

In recent years, aluminum materials have been used in, for example, vehicles to achieve weight reduction. However, the electrical conductivity and thermal conductivity of aluminum materials are higher than those of steel plates, and thus required current for welding of aluminum materials is higher than that for welding of steel plates. Therefore, when aluminum materials are welded by spot welding, special equipment, which is different from equipment for welding of steel plates, is required. The special equipment leads to increases in cost. Further, spot welding of aluminum materials has a disadvantage in energy saving. Moreover, a tip portion of the electrode may wear out rapidly.

In the spot welding electrode described in Japanese Patent Application Publication No. 2006-102775, the core embedded in the electrode body is connected at a plurality of surfaces to the electrode body. Thus, a tensile stress is likely to be applied to the embedded core in the cooling process after welding, and a fatigue failure of the electrode is likely to occur.

As described above, when aluminum materials are welded by spot welding using the spot welding electrode of related art, high welding current is required. Such high welding current leads to increases in cost, increases in energy consumption, and may cause wear-out of the welding electrode. The spot welding electrode of related art is susceptible to improvement in durability of the electrode, and it is desired that electrodes having a longer useful life be provided.

### SUMMARY OF THE INVENTION

The present invention provides a spot welding electrode that is configured to enable reduction in welding current and thus has a longer useful life.

The inventors of the present invention made a study of methods for solving the issue described above. As a result, the inventors found that in a case where a sintered tungsten alloy of a spot welding electrode is connected only at a single flat surface to a copper alloy and the thermal conductivity of the spot welding electrode is specified, the welding current is reduced and thus the spot welding electrode has a long useful life.

One aspect of the present invention relates to a spot welding electrode including a copper alloy and a sintered tungsten alloy disposed in a tip portion of the spot welding electrode, the tip portion of the spot welding electrode being brought into contact with an object to be welded. The sintered tungsten alloy is connected only at a single flat surface to the copper alloy. The thermal conductivity of the spot welding electrode is within a range from 60 W/mK to 120 W/mK. In the spot welding electrode, a mean particle diameter of the sintered tungsten alloy may be 3 μm or less. In the spot welding electrode, a part of the tip portion of the spot welding electrode, the part being brought into contact with the object to be welded, may have a continuous curved surface with no corner. In the spot welding electrode, the copper alloy may contain chromium. In the spot welding electrode, the sintered tungsten alloy may contain carbon. The spot welding electrode may be used for spot welding of an aluminum alloy material.

The one aspect of the present invention may provide a spot welding electrode that is configured to enable reduction in welding current and thus has a longer useful life.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a spot welding electrode according to an embodiment of the present invention;

FIG. 2 is a sectional view of a spot welding electrode of a comparative example; and

FIG. 3 is a graph showing the result of weld evaluation of the spot welding electrode of the comparative example and the result of weld evaluation of a spot welding electrode of an example of the embodiment of the present invention.

### DETAILED DESCRIPTION OF EMBODIMENTS

Hereinafter, an embodiment of the present invention will be described in detail.

The embodiment of the present invention relates to a spot welding electrode including a copper alloy and a sintered tungsten alloy.

The copper alloy included in the spot welding electrode of the embodiment of the present invention is an alloy containing copper (Cu) as the principal metal. The elements contained in the copper alloy other than copper are not limited to particular elements. Examples of the elements contained in the copper alloy other than copper include chromium (Cr), zirconium (Zr), nickel (Ni), silicon (Si), zinc (Zn), and beryllium (Be). From the viewpoint of prevention of deformation of the electrode, the copper alloy preferably contains chromium and/or beryllium. The copper alloy may contain two or more kinds of the above-mentioned elements as the elements other than copper.

The sintered tungsten alloy included in the spot welding electrode of the embodiment of the present invention is an alloy containing tungsten (W) as the principal metal, and the alloy containing tungsten (W) is produced by sintering. The elements contained in the sintered tungsten alloy other than tungsten are not limited to particular elements. Examples of the elements contained in the sintered tungsten alloy other than tungsten include Rhenium (Re), hafnium (Hf), thorium (Th), carbon (C), tantalum (Ta), zirconium (Zr), yttrium (Y), nickel (Ni), titanium (Ti), neodymium (Nd), niobium (Nb), zinc (Zn), potassium (K), calcium (Ca), aluminum (Al), lithium (Li), scandium (Sc), manganese (Mn), copper (Cu), iron (Fe), lanthanum (La), cerium (Ce), praseodymium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu). The sintered tungsten alloy preferably contains carbon. The sintered tungsten alloy may contain two or more kinds of the above-mentioned elements as the elements other than tungsten.

The methods of producing sintered tungsten alloys are not limited to particular methods. Sintered tungsten alloys may be produced by ordinary sintering methods. For example, tungsten and an element other than tungsten are mixed together, or tungsten, an element other than tungsten and, if needed, powder of additive are mixed together. Then, the mixture is formed into a columnar shape by cold isostatic pressing. Subsequently, electrodes are attached to respective ends of the mixture in a columnar shape, and the mixture with the electrodes is subjected to electric current sintering, so that a sintered body is produced. Then, the produced sintered body is subjected to hot roll forging, so that the sintered body is stretched in its longitudinal direction and the density of the sintered body is increased. When the diameter of the sintered body reaches a desired diameter, hot roll forging stops. Then, a sintered tungsten alloy body is produced by cutting and processing the sintered body. Another example of the methods of producing sintered tungsten alloys is as follows. Tungsten and an element other than tungsten are mixed together, or tungsten, an element other than tungsten and, if needed, powder of additive are mixed together. Then, a gastight container with flexibility is charged with the mixture, and the mixture is subjected to cold isostatic pressing. Subsequently, the mixture is sintered in an atmosphere of hydrogen, and then subjected to hot isostatic pressing, so that a sintered body is produced.

It is preferable that the mean particle diameter of the sintered tungsten alloy be 3 μm or less, so that the spot welding electrode has a long useful life. It is more preferable that the mean particle diameter of the sintered tungsten alloy be 1 μm or less. It is particularly preferable that the mean particle diameter of the sintered tungsten alloy be 0.5 μm or less. The mean particle diameter of the sintered tungsten alloy may be measured by the laser diffraction method.

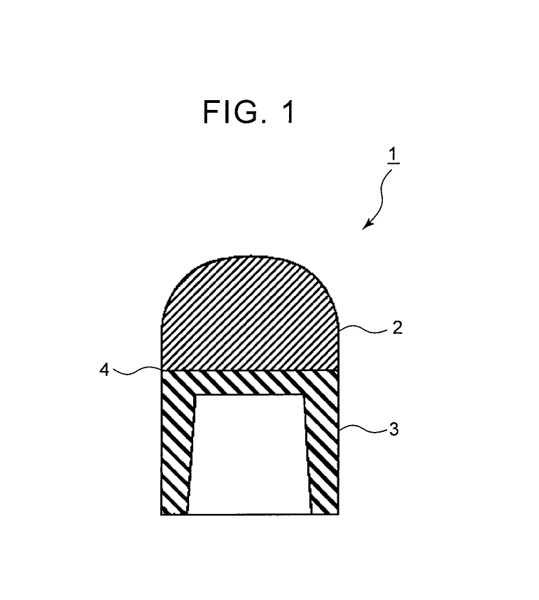

FIG. 1 is a sectional view of a spot welding electrode of the embodiment of the present invention. As shown in the FIG. 1, a spot welding electrode 1 of the embodiment of the present invention includes a sintered tungsten alloy 2 disposed in the tip portion of the spot welding electrode 1. The tip portion of the spot welding electrode 1 is brought into contact with an object to be welded. The sintered tungsten alloy 2 is connected only at a single flat surface 4 to a copper alloy 3. In the spot welding electrode 1 of the embodiment of the present invention, the sintered tungsten alloy 2, which has considerably high hardness at an elevated temperature and low thermal conductivity, is disposed in the tip portion of the spot welding electrode 1, so that metal materials to be welded, such as aluminum materials, are welded at a low current and at a remarkably low attrition rate of the tip portion. A crack is likely to occur in a spot welding electrode of related art, because a sintered tungsten alloy is connected at two or more surfaces to a copper alloy. In contrast to this, in the spot welding electrode 1 of the embodiment of the present invention, the sintered tungsten alloy 2 is connected only at the single flat surface 4 to the copper alloy 3. Therefore, a crack does not occur in the spot welding electrode 1 of the embodiment of the present invention, and thus the spot welding electrode 1 of the embodiment of the present invention has a longer useful life.

The thermal conductivity of the spot welding electrode 1 of the embodiment of the present invention is within a range from 60 W/mK to 120 W/mK, and preferably within a range from 70 W/mK to 100 W/mK. Because the thermal conductivity of the spot welding electrode 1 of the embodiment of the present invention is 60 W/mK or more, the spot welding electrode 1 is prevented from being melted and stuck to an object to be welded. Further, the thermal conductivity of the spot welding electrode 1 of the embodiment of the present invention is 120 W/mK or less, and thus the required current for welding is reduced. The thermal conductivity may be measured by a measuring method such as the thermal gradient method, the laser flash method or the hot wire method.

The thermal conductivity of the spot welding electrode 1 of the embodiment of the present invention may be adjusted by changing the volume ratio between the sintered tungsten alloy 2 and the copper alloy 3.

The spot welding electrode 1 of the embodiment of the present invention is preferably formed such that a part of the tip portion of the spot welding electrode 1, the part being brought into contact with an object to be welded, has a continuous curved surface with no corner. This configuration prevents formation of small cracks in the spot welding electrode 1, thereby preventing the spot welding electrode 1 from cracking.

The spot welding electrode 1 of the embodiment of the present invention is used in the state where the spot welding electrode 1 is attached to an electrode holder via, for example, a shank.

The spot welding electrode 1 of the embodiment of the present invention may be produced in ordinary methods. For example, powder of a tungsten alloy is disposed in a predetermined die corresponding to the tip portion of the spot welding electrode 1, and powder of a copper alloy is disposed in a predetermined die corresponding to a body portion of the spot welding electrode 1. Then, the powder of the copper alloy and the powder of the sintered tungsten alloy are sintered by the application of heat under pressure. In this way, the spot welding electrode is produced.

The embodiment of the present invention includes a welding method for welding objects to be welded, using the above-described spot welding electrodes. In the welding method of the embodiment of the present invention, the above-described spot welding electrodes are disposed so as to face each other, and the spot welding electrodes are energized while objects to be welded are held together under pressure exerted by the spot welding electrodes. In this way, the overlapped objects to be welded are melted by Joule heat generated in the spot welding electrodes, so that the objects to be welded are joined together.

The objects to be welded used in the welding method of the embodiment of the present invention are not limited to particular objects. Examples of the objects to be welded include steel plates, aluminum alloy materials, copper alloy materials, and nickel alloy materials. Preferably, galvanized steel sheets or aluminum alloy materials are used. Two kinds of materials may be used as the objects to be welded. When the spot welding electrode of the embodiment of the present invention is used for welding of aluminum alloy materials, it is possible to weld the aluminum alloy materials at lower currents. This makes it possible to weld aluminum alloy materials using the same equipment as that used in welding of steel sheets.

An example of the embodiment of the present invention will be described in detail. However, the technical scope of the invention is not limited to the following example.

The example will be described below. The spot welding electrode 1 configured as illustrated in FIG. 1 was manufactured. Chromium copper was used as a copper alloy, and sintered tungsten carbide (having a mean particle diameter of 3 μm) was used as a sintered tungsten alloy.

The thermal conductivity of the spot welding electrode was measured by the thermal gradient method. The thermal conductivity of the spot welding electrode of the example was 70 W/mK.

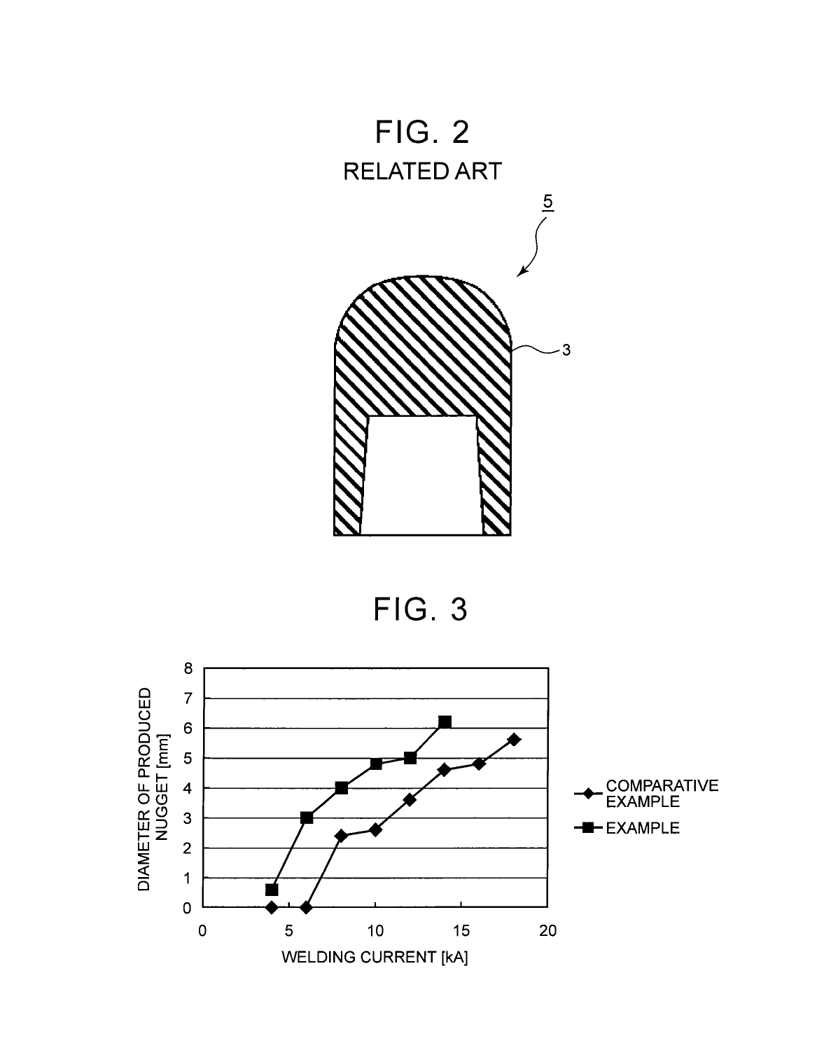

A comparative example will be described below. A spot welding electrode 5 configured as illustrated in FIG. 2 was manufactured using chromium copper as a copper alloy. The thermal conductivity of the spot welding electrode of the comparative example was 320 W/mK.

The evaluation of welding in the example and the evaluation of welding in the comparative example will be described in detail below. The spot welding electrodes of the example were disposed so as to face each other, and the spot welding electrodes of the comparative example were disposed so as to face each other. Then, spot welding was performed while the welding current value was changed, under the conditions that the welding force was 100 kgf and the energization time was six cycles. In spot welding, the spot welding electrodes of the example and the spot welding electrode of the comparative example were energized while objects to be welded were held together under pressure exerted by the corresponding spot welding electrodes. Aluminum alloy materials having a thickness of 1.2 mm were used as objects to be welded. The welding strength was evaluated by measuring the diameter of a created weld nugget (a portion formed after solidification of the molten portion of the objects to be welded). The larger the diameter of the produced nugget is, the higher the welding strength is. The results of the evaluations are shown in FIG. 3.

As shown in FIG. 3, the welding current required by the spot welding electrode of the example to produce a nugget having a given diameter was lower by approximately 50% than the welding current required by the spot welding electrode of the comparative example to produce a nugget having the given diameter. Also, a crack does not occur in the sintered tungsten carbide of the spot welding electrode of the example.

The spot welding electrode of the embodiment of the present invention may be used for welding of materials used in automobiles, aircrafts, and railroad vehicles.

What is claimed is:

1. A spot welding electrode comprising:
a copper alloy; and
a sintered tungsten alloy disposed in a tip portion of the spot welding electrode, the tip portion of the spot welding electrode being brought into contact with an object to be welded, wherein
the sintered tungsten alloy is connected only at a single flat surface to the copper alloy, and
a thermal conductivity of the spot welding electrode is within a range from 60 W/mK to 120 W/mK.

2. The spot welding electrode according to claim 1, wherein a mean particle diameter of the sintered tungsten alloy is 3 μm or less.

3. The spot welding electrode according to claim 1, wherein a part of the tip portion of the spot welding electrode, the part being brought into contact with the object to be welded, has a continuous curved surface with no corner.

4. The spot welding electrode according to claim 1, wherein the copper alloy contains chromium.

5. The spot welding electrode according to claim 1, wherein the sintered tungsten alloy contains carbon.

6. A method of spot welding comprising:
using the spot welding electrode according to claim 1 for spot welding of an aluminum alloy material.
